(19) United States
(12) Patent Application Publication
(10) Pub. No.: US 2021/0364652 A1
(43) Pub. Date: Nov. 25, 2021

(54) METHOD AND DEVICE FOR POSITIONING DETERMINATION BY INERTIAL NAVIGATION, AND CALIBRATION SYSTEM

(71) Applicant: CHRONOS VISION GMBH, Berlin (DE)

(72) Inventor: Saso Spasovski, Berlin (DE)

(21) Appl. No.: 17/345,169

(22) Filed: Jun. 11, 2021

Related U.S. Application Data
(63) Continuation of application No. PCT/DE2019/000305, filed on Nov. 29, 2019.

(30) Foreign Application Priority Data
Dec. 11, 2018 (DE) 10 2018 009 913.0

(51) Int. Cl. G01S 19/47; G01S 19/49; G01S 19/23

(52) U.S. Cl. CPC G01S 19/47; G01S 19/23; G01S 19/49

(57) ABSTRACT

In a method and with a device for position determination by inertial navigation, a current position is determined from a known starting position and starting orientation by sensing accelerations and rotation rates. To do this, sensors are used to sense accelerations and rotation rates, and the accelerations and rotation rates acting on the sensors along or about three sensor axes are calculated. An evaluation device is used to determine a position from the data of the individual sensors, and the vector components of the positions determined are then added in a weighted manner. The weightings are determined by calibration.

### CROSS-REFERENCE TO RELATED APPLICATIONS

This application is a continuation of and claims priority to PCT/DE2019/000305 filed Nov. 29, 2019, which claims priority to German Patent Application No. 102018009913.0 filed Dec. 11, 2018, the entire disclosures of which are incorporated by reference herein.

### TECHNICAL FIELD

The disclosure herein relates to a method for position determination by inertial navigation, wherein a current position is determined from a known starting position and orientation by measuring accelerations and rotation rates. Moreover, the disclosure herein relates to a device for position determination by inertial navigation with a multiplicity of sensors for measuring accelerations and rotation rates. Furthermore, the disclosure herein relates to a calibration system for calibrating the device.

### BACKGROUND

Ascertaining the current spatial position of an object is often realized by way of global or regional satellite-based position determination systems (GNSS), such as e.g. GLONASS, Galileo, GPS, Beidou, IRNSS or QZSS, and corresponding receivers. However, the applicability of the technology in the field of navigation is limited to situations in which reception of the signals is ensured. Because of the relatively low transmission power and the resultant low field strength of the satellite signals, shields of any kind constitute a serious obstacle to the functioning of a GNSS.

Besides this physically substantiated limitation, by which satellite-based navigation for example in buildings, below the surface of water and in underground mining can be severely disrupted or even rendered impossible, electromagnetic interference transmitters constitute a further hazard for position determination by GNSS. By way of example, so-called spoofers can manipulate the satellite signal, while so-called jammers can partially or completely disturb or prevent reception of the signal.

The basic functioning of inertia-based navigation systems, also called INS, is based on measuring linear accelerations and rotation rates along or about three pairwise linearly independent body axes. On the basis of classical mechanics, given knowledge of the initial spatial position, velocity and alignment, the initial conditions, firstly the alignment or orientation is obtained from the continuously measured rotation rates about the three axes by way of a simple integration. Together with the likewise continuously measured linear acceleration, corrected for the acceleration due to gravity, an integration yields the current velocity and a further integration yields the instantaneous spatial position of a moving body.

Despite the fact that no electromagnetic signals or optical marks are used, such systems have some serious disadvantages. These disadvantages are manifested particularly when cost-effective MEMS-based inertial sensors are used, such that navigation is possible with sufficient positional accuracy only for a relatively short period of time. One of the main problems of inertia-based sensor systems is the bias error. Even small magnitudes of this error result in movement drift, which is manifested for example in the fact that a movement is derived computationally from the measured acceleration data of a body at rest, but the movement does not actually take place. Because of the double integration during the position calculation, the position error increases quadratically with time. This has the effect that the position determination can become unusable within minutes.

### SUMMARY

FIGS. 1A and 1B show examples of the influence of low noise and a small bias error of the data of an acceleration sensor on the calculated velocity in the X-direction (FIG. 1A) and on the X-coordinate of the current position (FIG. 1B), without an actual movement taking place. In these figures here in each case a straight, dashed line 1 shows the actual value, while in each case a curved, continuous line 2 shows the value ascertained from the data of the sensor.

The problem addressed by the disclosure herein is that of increasing the accuracy of the position determination in surroundings or situations in which reliable reception of electromagnetic signals including visible light is not possible or a corresponding technical infrastructure is not present.

In order to solve this problem the disclosure herein provides a method for position determination by inertial navigation, wherein a current position is determined from a known starting position and starting orientation by detecting accelerations and rotation rates, comprising the following steps: providing sensors for detecting accelerations and rotation rates; calculating the accelerations and rotation rates acting on the sensors along or about three sensor axes over a time period; wherein a position is ascertained in each case from the data of the individual sensors and the vector components of the ascertained positions are subsequently added in a weighted manner, wherein the weights are ascertained by calibration.

Preferably, for the purpose of ascertaining the current position, a nonlinear combination of the vector components of the positions of a multiplicity of sensors (10) is formed, wherein the vector components and in each case at least the second power thereof are summed in a separately weighted manner.

By way of example, for the purpose of calibration, from a multiplicity of sensor combinations for each coordinate direction a number of sensor combinations are selected, each of which satisfies at least one quality criterion.

Advantageously, the quality criterion is satisfied if for each coordinate direction at the end of the calibration the sum of the deviations of the coordinates of the positions of the individual sensors of the respective sensor combination from the actual value of the coordinate of the current position lies below a defined limit value.

Preferably, the quality criterion is satisfied if for each coordinate direction at the end of the calibration the deviation of the centroid of the coordinates of the positions of the individual sensors of the respective sensor combination from the actual value of the coordinate of the current position lies below a defined limit value.

By way of example, the quality criterion is satisfied if for each coordinate direction the sum—integrated over the calibration time period—of the deviations of the individual coordinates of the positions of the sensors associated with the sensor combination from the actual value of the coordinate of the current position lies below a defined limit value.

Advantageously, a number of sensor combinations are selected which satisfy at least one quality criterion at different points in time during the calibration.

Preferably, a predefined minimum and/or maximum number of sensor combinations which satisfy the quality criterion are selected.

By way of example, for the purpose of determining the weights for each of the selected sensor combinations a spatial coordinate of the centroid of the corresponding coordinates of the current positions of the individual sensors of the sensor combination is calculated.

Advantageously, for the purpose of determining the weights a spatial coordinate of the centroid of the centroids of the corresponding coordinates is calculated.

Preferably, for the purpose of determining the weights the deviations of the corresponding coordinates of the current positions of the individual sensors of the selected sensor combinations from the actual value of the corresponding coordinate of the current position are used for each coordinate direction.

By way of example, for the purpose of determining the weights an overdetermined system of equations is solved for each coordinate direction.

Advantageously, the weights of the sensors for each coordinate are formed from coefficients of a linear combination of corresponding coordinates of the positions associated with the sensors.

Another aspect of the disclosure herein provides a device for position determination by inertial navigation, comprising a multiplicity of sensors for detecting accelerations and rotation rates along or about the respective sensor axes thereof, and an evaluation unit for calculating a current position from the detected accelerations and rotation rates, wherein the evaluation unit is designed in such a way that it ascertains a position in each case from the data of the individual sensors and subsequently adds the vector components of the ascertained positions in a weighted manner, wherein the weights are ascertained by a calibration of the sensors.

Advantageously, the evaluation unit is configured for carrying out the method according to the disclosure herein.

Preferably, the device comprises means for thermally decoupling the sensors from the surroundings and/or thermocouples for compensating for temperature changes.

By way of example, the device comprises a unit for mechanically damping the sensors.

Preferably, the device is used in an aircraft, land vehicle or watercraft, which can be manned or unmanned, for example, and/or it is embodied as a portable navigation device for persons and/or for use under water, such as for diving operations, in particular.

A further aspect of the disclosure herein provides a calibration system comprising a device according to the disclosure herein and a calibration unit for calibrating the device according to the disclosure herein.

Advantageously, at least 25, preferably at least 36, and particularly preferably at least 42 or 100 sensors are used in the device and/or in the method.

Preferably, more than 50, particularly preferably more than 100 good sensor combinations are ascertained. “Good sensor combinations” are sensor combinations that satisfy at least one quality criterion.

By way of example, the good sensor combinations each comprise more than 10 sensors, preferably between 12 and 36 sensors.

For example, the computation time for determining the weights with e.g. 100 sensors, with the use of a customary computer, can be in the range of a few minutes. With the computer having higher performance, the computation time can also be shorter.

The determination of the weights can also be carried out with the aid of a PC, for example, which is integrated directly into a charging station, for example. Once the weights have been determined with the aid of the external PC, they are transferred to the device or to the navigation device and the system can be used, for example by a user.

The disclosure herein solves the abovementioned problems in the prior art by dispensing with the evaluation of satellite signals. Generally, any electromagnetic radiation as carrier of information is dispensed with. The disclosure herein thus differs fundamentally from localization technologies such as Wi-Fi-based locating, beacons, time of flight by UWB, VLC, where light signals are used for navigation, and from camera-based solutions such as stereovision, triangulation, etc.

This property predestines the disclosure herein for use in surroundings and situations in which reliable reception of EM signals (including visible light) is not possible or a corresponding technical infrastructure is not present. This includes the localization of emergency and rescue personnel for example in the event of mine accidents, building fires, diving missions or navigation at sea, on the ground or in air space in the event of disturbed or manipulated GPS reception.

The disclosure herein can be considered to be associated with inertia-based navigation systems. It can for example also be referred to or described as inertial navigation by an IMU matrix (Inertial Measurement Unit).

The disclosure herein uses for example a number of so-called inertial measurement units (IMUs), fabricated using microsystems technology (micro electro mechanical system—MEMS), as sensors.

By way of example, a matrix of inertial measurement units is used.

Unless explicitly precluded, then it is assumed hereinafter that the sensors or IMU sensors each contain a digital three-axis acceleration sensor and a three-axis digital gyroscope or rotation rate sensor. However, it is not a necessary condition that acceleration sensors and gyroscopes be situated in the same housing. Some IMUs additionally contain a digital thermometer and a three-axis digital magnetometer.

The disclosure herein is based on the following considerations:

Each sensor yields, for each of the three axes, a stream of data identifying the linear acceleration and rotation rate. The simplest model fixes a linear ratio for the relationship of sensor value and movement variables. For the linear acceleration and the rotation rate along and about the X-axis, for example, the following mapping or transformation specification then approximately holds true:

aₓ=scₐₓ(a_{x,s}−biasₐₓ)=scₐₓa_{x,s}+offsetₐₓ (1)

ωₓ=sc_{ωx}(ω_{x,s}−bias_{ωax})=sc_{ωx}ω_{x,s}+offset_{ωx} (2)

The parameters are sensor-specific. aₓ and cox denote the actual acceleration and angular velocity or rotation rate along and about the sensor X-axis, a_{x,s} and ω_{x,s} denote the raw values transmitted by the sensor for the linear acceleration and rotation rate in and about the sensor X-direction, scₐₓ and sc_{ωx} denote the scaling factors, and bias_{ωx} and bias_{ωx} respectively denote the values transmitted by an IMU in the case of a vanishing acceleration and rotation rate along and about the sensor X-axis (aₓ=0, ωₓ=0).

The parameters scₐₓ, scωₓ, biasₐₓ and bias_{ωx} of the above mapping are determined by way of a calibration process, but the latter is not part of the disclosure herein. For differentiation from the calibration described further below, the latter is called parameter calibration hereinafter.

In principle, in the simplest model, because of the linear character of the mapping, each of the three sensor axes is aligned e.g. parallel and then antiparallel to the direction of acceleration due to gravity. The raw sensor values recorded in the meantime correspond to the acceleration of 1 g and −1 g, respectively, or 9.81 m/s² and −9.81 m/s². For the purpose of calibrating the parameters for the rotation rates about the respective axes, the sensors are rotated about the corresponding axis with at least two different but known angular velocities.

The drift described above is caused, inter alia, by noise and by the fact that the scaling parameters and in particular the bias values, even after a parameter calibration, are known only with limited accuracy and can vary slightly after each turn-on of the IMU (turn-on to turn-on bias or turn-on instability).

FIGS. 2, 3A and 3B show a possible histogram and the distributions of the bias error (as raw sensor values) of the linear acceleration among the individual sensors of the matrix. The bias error of the linear acceleration and rotation rate along and about an axis can be defined as the deviation of the respective current bias value for this axis from the true value.

FIG. 2 here shows a histogram of the bias errors (in raw sensor values) of the linear acceleration for the X-axis in the case of 36 IMU sensors.

FIGS. 3A and 3B show a possible distribution of the bias error (in raw sensor values) of the linear acceleration for the X- and Y-axes in the case of 36 IMU sensors. The diagram illustrated shows that the bias errors assume different values for each sensor and for each axis.

The approach underlying the disclosure herein for the calculation of the trajectory and thus the current position differs from that of existing navigation systems with one or more IMUs. The primary aim is not to minimize the noise of the sensor values by applying an intelligent filter, or to identify the influence of other effects, parameters and variables and to include that in a suitable manner in order to obtain optimized properties with regard to the drift behavior, or in order generally to prevent a position error or keep it small.

Instead, the path taken in this disclosure herein involves optimizing the current position determination by a weighting of the positions calculated with the aid of the individual sensors in such a way that e.g. a linear combination of the X-coordinates of the positions associated with the individual sensors of the IMU matrix results in a more accurate X-coordinate.

The basic concept consists in or comprises firstly considering each IMU of the arrangement separately and calculating in each case the associated trajectory or the current position by customary and known methods from the continuously measured sensor data read out by a microcontroller, for example, with the aid of a suitable computing architecture.

Usually, with the use of N sensors, e.g. because of noise and the sensor-specific bias error mentioned above, results obtained are generally N different trajectories and thus also N current positions in space, which may deviate, in some instances very greatly, from the actual trajectory and current spatial position (see FIG. 4).

FIG. 4 shows the calculated current positions 41 of the individual sensors of an arrangement of 36 IMU sensors (crosses) after a calibration time duration of 10 minutes (the Z-coordinate has been omitted); the system was in the rest state during the calibration. It is very clearly evident that after 10 minutes the deviation of the calculated values from the sensor data, which are represented as crosses 41, from the rest position 42 (x=0, y=0) situated in the center of the graph illustrated, is up to approximately 2 or 3 km or more.

The concept of the disclosure herein is based on the fact that instead of the trajectory coordinates calculated individually for each sensor, the components of the linear acceleration and the rotation rate of the individual sensors can also be weighted in a suitable manner in order thereby to generate continuously for every point in time a representative, individual substitute value for the components of the acceleration and rotation rate, with the aid of which the current orientation and spatial position can be calculated.

The arrangement as a matrix is not relevant here. By way of example, the sensors can be arranged in a single row or totally arbitrarily as long as the positions are known and the three sensor axes of all the IMUs are parallel in each case. This also affords advantages in the parameter calibration since then all the sensors can be calibrated simultaneously in order to determine the respective sensor-specific scaling factors and bias values.

As the number N of sensors increases, the probability rises that the calculation of an average trajectory or the formation of the centroid of all N current position results will lead to a more accurate result in the calculation of the actual trajectory or the actual position in space.

The centroid \vec{rₛ} represents the vector sum of all current positions {\vec{rₙ}|n=1 . . . N} originating from the individual sensors divided by N and can be regarded mathematically as a linear combination of the N current positions with the identical coefficients 1/N:

$$\vec{{r}_{s}} : = \frac{1}{N} {\sum }_{n = 1}^{N} \vec{{r}_{n}} = \frac{1}{N} \vec{{r}_{1}} + \frac{1}{N} \vec{{r}_{2}} + \text{…} + \frac{1}{N} \vec{{r}_{N}} ⇔ ( \begin{matrix}{X}_{s} \\ {Y}_{s} \\ {Z}_{s}\end{matrix} ) = \frac{1}{N} ( \begin{matrix}{X}_{1} \\ {Y}_{1} \\ {Z}_{1}\end{matrix} ) + \frac{1}{N} ( \begin{matrix}{X}_{2} \\ {Y}_{2} \\ {Z}_{2}\end{matrix} ) + \text{…} + \frac{1}{N} ( \begin{matrix}{X}_{N} \\ {Y}_{N} \\ {Z}_{N}\end{matrix} ) \qquad ( 3 )$$

Despite an improvement in accuracy, the error, i.e. the deviation between the actual current position and that calculated by way of averaging, after just a short time exceeds a magnitude which makes this procedure seem unsuitable for navigation (see FIG. 5).

FIG. 5 shows the error 51 of the calculated X-coordinate for all the sensors of the IMU arrangement after 10 minutes. The arithmetic mean of the deviations is approximately 200 m.

However, the probability also rises that the centroid of the current positions of only a subset of the sensors will lead to a more accurate result. By way of example, if the individual results of the sensors drift unsystematically into different directions, then once the number of sensors is large enough it is probable that the drift of one individual sensor will be compensated for by the drift of another individual sensor. However, centroid formation as a special case of a linear combination with identical coefficients is not the only possibility for combining the sensor results.

The central concept of this disclosure herein follows a more general approach and consists in or comprises carrying out, for the purpose of the current position determination, component by component a weighted addition of the individual coordinates or their powers of all current IMU position vectors. Simulation calculations have confirmed that this procedure, with regard to accuracy, usually leads to more accurate results than traditional centroid formation. The weights or contributions of the individual IMUs for the three spatial coordinates will be different with very high probability, and so a dedicated set of N weights or weight vector is to be fixed for each of the coordinates X, Y, Z of the current position, that is to say

wx=(wx₁, . . . ,wx_{N})

wy=(wy₁, . . . ,wy_{N})

wz=(wz₁, . . . ,wz_{N}) (4)

By way of example, it is very probable that the weight of the IMU sensor Sⱼ when ascertaining the X-coordinate of the instantaneous position will deviate from the weight for the Y- and Z-coordinates:

wx₁≠wyᵢ≠wzᵢ.

It is also entirely conceivable for these weight vectors not to represent temporal constants and to be dependent on temperature, for example, such that for each coordinate it is necessary to use different weight vectors for different time segments and temperatures.

In principle, the temperature of the IMUs could be kept relatively constant to a certain degree and with a certain outlay (thermal insulation, heating and/or cooling elements, early turn-on, etc.). Alternatively, the calibration process described further below can also be carried out for different temperatures. For these reasons, the temperature influence will initially not be considered further.

In the simplest case, the weight vectors for each coordinate, i.e. wx, wy and wz, are constant over time and not or no longer temperature-dependent (see above).

The approach for calculating the coordinates of the current position then reads:

$$\vec{r} ( t ) = ( \begin{matrix}X ( t ) \\ Y ( t ) \\ Z ( t )\end{matrix} ) ≅ {\sum }_{n = 1}^{N} ( \begin{matrix}w {x}_{n} \\ w {y}_{n} \\ w {z}_{n}\end{matrix} ) ∘ \vec{{r}_{n}} ( t ) = {\sum }_{n = 1}^{N} ( \begin{matrix}w {x}_{n} \\ w {y}_{n} \\ w {z}_{n}\end{matrix} ) ∘ ( \begin{matrix}{X}_{n} ( t ) \\ {Y}_{n} ( t ) \\ {Z}_{n} ( t )\end{matrix} ) = \\ ( \begin{matrix}w {x}_{1} \\ w {y}_{1} \\ w {z}_{1}\end{matrix} ) ∘ ( \begin{matrix}{X}_{1} ( t ) \\ {Y}_{1} ( t ) \\ {Z}_{1} ( t )\end{matrix} ) + ( \begin{matrix}w {x}_{2} \\ w {y}_{2} \\ w {z}_{2}\end{matrix} ) ∘ ( \begin{matrix}{X}_{2} ( t ) \\ {Y}_{2} ( t ) \\ {Z}_{2} ( t )\end{matrix} ) + \text{…} + ( \begin{matrix}w {x}_{N} \\ w {y}_{N} \\ w {z}_{N}\end{matrix} ) ∘ ( \begin{matrix}{X}_{N} ( t ) \\ {Y}_{N} ( t ) \\ {Z}_{N} ( t )\end{matrix} ) ⇔ \\ ( \begin{matrix}X ( t ) \\ Y ( t ) \\ Z ( t )\end{matrix} ) = {\sum }_{n = 1}^{N} ( \begin{matrix}w {x}_{n} & {X}_{n} ( t ) \\ w {y}_{n} & {Y}_{n} ( t ) \\ w {z}_{n} & {Z}_{n} ( t )\end{matrix} ) \qquad ( 5 )$$

(the operator ∘ denotes the Hadamard product) or in components:

X(t)≈wx₁X₁(t)+wx₂X₂(t)+ . . . +wx_{N}X_{N}(t)

Y(t)≈wy₁Y₁(t)+wy₂Y₂(t)+ . . . +wy_{N}Y_{N}(t)

Z(t)≈wz₁Z₁(t)+wz₂Z₂(t)+ . . . +wz_{N}Z_{N}(t) (6)

or more compactly with the aid of the scalar product:

X(t)≈ [symbol] wx,\vec{X}(t)

[symbol]

Y(t)≈ [symbol] wy,\vec{Y}(t)

[symbol]

Z(t)≈ [symbol] wz,\vec{Z}(t) [symbol] (7)

with

\vec{X}(t):=(X₁(t), . . . ,X_{N}(t))

\vec{Y}(t):=(Y₁(t), . . . ,Y_{N}(t))

\vec{Z}(t):=(Z₁(t), . . . ,Z_{N}(t))

and the weight vectors:

wx=(wx₁, . . . ,wx_{N})

wy=(wy₁, . . . ,wy_{N})

wz=(wz₁, . . . ,wz_{N}) (8)

The formulation by a scalar product shows particularly clearly the basic concept of the approach that the individual coordinates of the current position emerge from the corresponding coordinates of the individual sensors with separate weighting in each case.

However, it is also conceivable for a nonlinear combination to yield more accurate results than the linear variant. The following arises by way of example for the X-coordinate and with 2 as the highest power for the current X-coordinates of the individual IMUs:

X(t)≈wx₁₁X₁(t)+wx₁₂X₁²(t)+ . . . +wx_{N1}X_{N}(t)+wx_{N2}X_{N}²(t) (9)

The associated weight vector then has double the number of components:

wx=(wx₁₁,wx₁₂, . . . ,wx_{N1},wx_{N2}) (10)

As mentioned in the introduction, the previous considerations can also be applied to the components of the linear accelerations and rotation rates. The approaches for calculating the components of the instantaneous linear acceleration and the rotation rates along and about the sensor axes then read (the time dependence is omitted for simplification):

a_{X}≅wax₁a_{X,1}+wax₂a_{X,2}+ . . . +wax_{N}a_{X,N}

a_{Y}≅way₁a_{Y,1}+way₂a_{Y,2}+ . . . +way_{N}a_{Y,N}

a_{Z}≅waz₁a_{Z,1}+waz₂a_{Z,2}+ . . . +waz_{N}a_{Z,N}

and

ω_{X}≅wgx₁ω_{X,1}+wgx₂ω_{X,2}+ . . . +wgx_{N}ω_{X,N}

ω_{Y}≅wgy₁ω_{Y,1}+Wgy₂ω_{Y,2}+ . . . +wgy_{N}ω_{Y,N}

ω_{Y}≅wgz₁ω_{Z,1}+wgz₂ω_{Z,2}+ . . . +wyz_{N}ω_{Z,N} (11)

with the weight vectors

wax=(wax₁, . . . ,wax_{N})

way=(way₁, . . . ,way_{N})

waz=(waz₁, . . . ,waz_{N})

and

wgx=(wgx₁, . . . ,wgx_{N})

wgy=(wgy₁, . . . ,wgy_{N})

wgz=(wgz₁, . . . ,wgz_{N}). (12)

In this case, for example, a_{X,n}: =a_{X,n}(t) and ω_{X,n}: =ω_{X,n}(t) denote the current linear acceleration and rotation rate along and about the X-axis of the sensor Sₙ, which are derived from the associated sensor data using the parameters bias_{ax,n}, sc_{ax,n}, bias_{ωx,n} and sc_{ωx,n} (from the parameter calibration) (see formulae (1) and (2)).

If the weight vectors have been determined in a calibration process, then exactly one substitute value for the linear acceleration and one substitute value for the rotation rate can be ascertained from the raw data of all N sensors for each IMU axis and at each point in time. As a result, it is possible to treat the sensor matrix like a single IMU. The orientation and spatial position of the system can then be determined according to customary and known methods, which are not part of this disclosure herein.

In principle, here the acceleration vector measured by an IMU in its own reference system (“body frame”) is transformed into the world coordinate system (“earth frame”) after, firstly, the instantaneous orientation in relation to an initial orientation has been ascertained with the aid of the three-axis gyroscope of the IMU by a simple integration of the angular velocity or rotation rate (see formula (14)) and, secondly, the acceleration due to gravity has been subtracted from the acceleration vector mentioned above. A double integration of the acceleration in the world coordinate system yields the position relative to a known initial position.

Instead of the angular velocity or rotation rate, alternatively it is also possible to develop the orientation angles about the three world axes according to the corresponding angles of the individual IMUs:

φ_{X}≅wgx₁φ_{X,1}+wgx₂φ_{X,2}+ . . . +wgx_{N}φ_{X,N}

φ_{Y}≅wgy₁φ_{Y,1}+wgy₂φ_{Y,2}+ . . . +wgy_{N}φ_{Y,N}

φ_{Y}≅wgz₁φ_{Z,1}+wgz₂φ_{Z,2}+ . . . +wgz_{N}φ_{Z,N} (13)

By way of example, it holds true for the sensor Sᵢ that the current rotation angle position about the Y-axis of the world coordinate system can be calculated with the aid of an initial angle position φ_{Y,i}(t₀) and the following formula:

φ_{Y,i}=φ_{Y,i}(t)=φ_{Y,i}(t₀)+ω_{Y,i}(t₁)Δt+ω_{Y,i}(t₂)Δt+ . . . +ω_{Y,i}(t)Δt (14)

This involves the integral of a staircase function, the steps ω_{Y,i}(tₙ) of which are given by the raw data for the sensor Y-axis transmitted by the gyroscope of the IMU Sᵢ until the point in time t, which, however, were additionally transformed into rotation rates with the aid of an associated scaling factor and bias or offset value from the parameter calibration. The time intervals occurring as factors in the summands result from the reciprocal of the read-out rate and need not necessarily be identical. The shorter the time intervals, the more accurately the integral of the rotation rate and thus of the angles about the Y-axis is approximated by way of the expression above.

### BRIEF DESCRIPTION OF THE DRAWINGS

Example embodiments of the disclosure herein are explained in greater detail below with reference to the accompanying drawings, in which:

FIGS. 1A, 1B show a diagram of one example of the influence of low noise and a small bias error of the data of an acceleration sensor on the calculated X-coordinate of the velocity and the position;

FIG. 2 shows an example histogram of the bias errors of the linear acceleration for the X-axis in the case of 36 IMU sensors;

FIGS. 3A, 3B show a possible distribution of the bias error of the linear acceleration for the X- and Y-axes in the case of 36 IMU sensors;

FIG. 4 shows an example of the calculated current positions of individual sensors of an arrangement of 36 IMU sensors after a calibration time duration of 10 minutes;

FIG. 5 shows by way of example the errors of a calculated X-coordinate for all the sensors of an IMU arrangement after 10 minutes;

FIGS. 6A, 6B show a device for position determination in accordance with one preferred embodiment of the disclosure herein as a schematic illustration;

FIG. 7 shows a histogram of the accumulated deviations per sensor subset in the case of a large number of sensor subsets (>10⁵);

FIG. 8 shows an example of good subsets or sensor combinations for calculating the X- and Y-coordinates of the current position;

FIG. 9 shows an example of an actual planar trajectory and a planar trajectory calculated by weight vectors for an arrangement of 25 IMU sensors;

FIGS. 10A, 10B show the temporal development of the X- and Y-errors of the calculated trajectory shown in FIG. 9;

FIG. 11 shows an example of the detection of a movement of a person after 12 minutes according to the method according to the disclosure herein;

FIG. 12 shows a block diagram of one example embodiment of the method according to the disclosure herein as a schematic illustration;

FIG. 13 shows a block diagram schematically illustrating a calibration in accordance with one example embodiment of the disclosure herein; and

FIG. 14 shows a calibration system 200 in accordance with one preferred embodiment of the disclosure herein as a schematic illustration.

### DETAILED DESCRIPTION

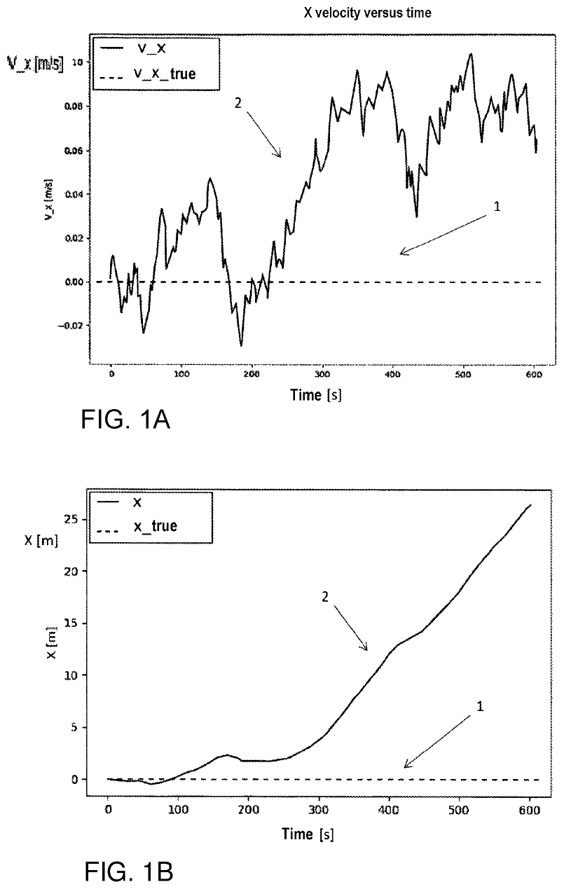

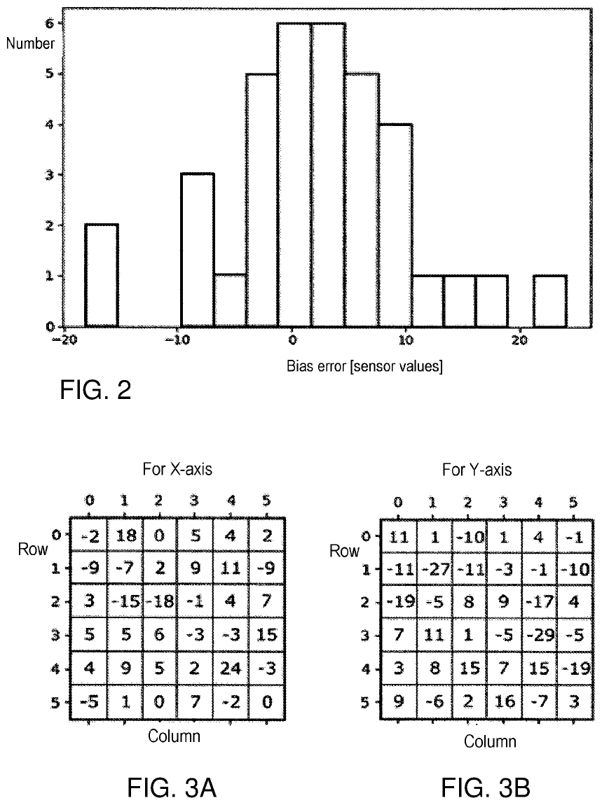

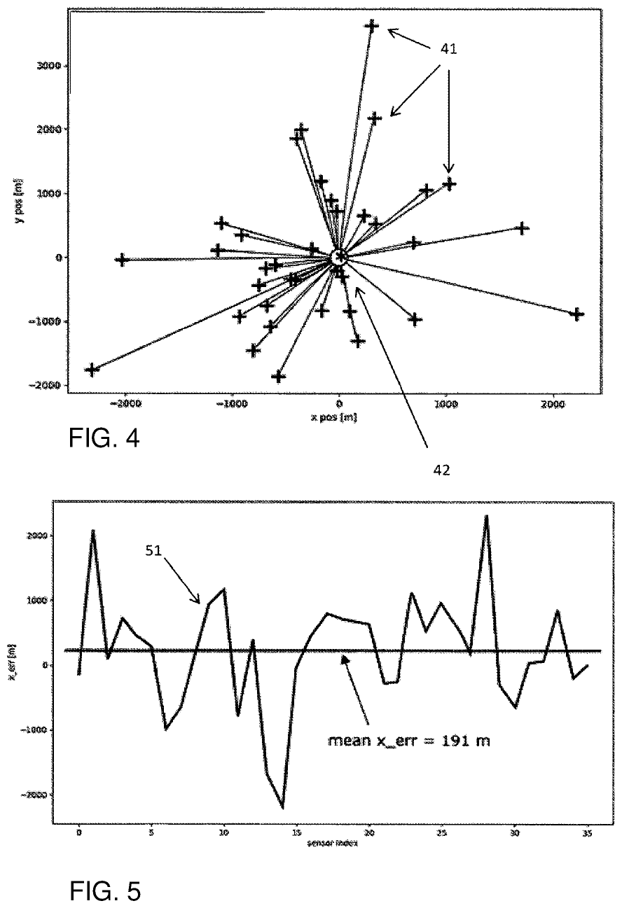

FIGS. 1 through 5 serve for elucidating the general basic considerations concerning the disclosure herein. They have already been explained above.

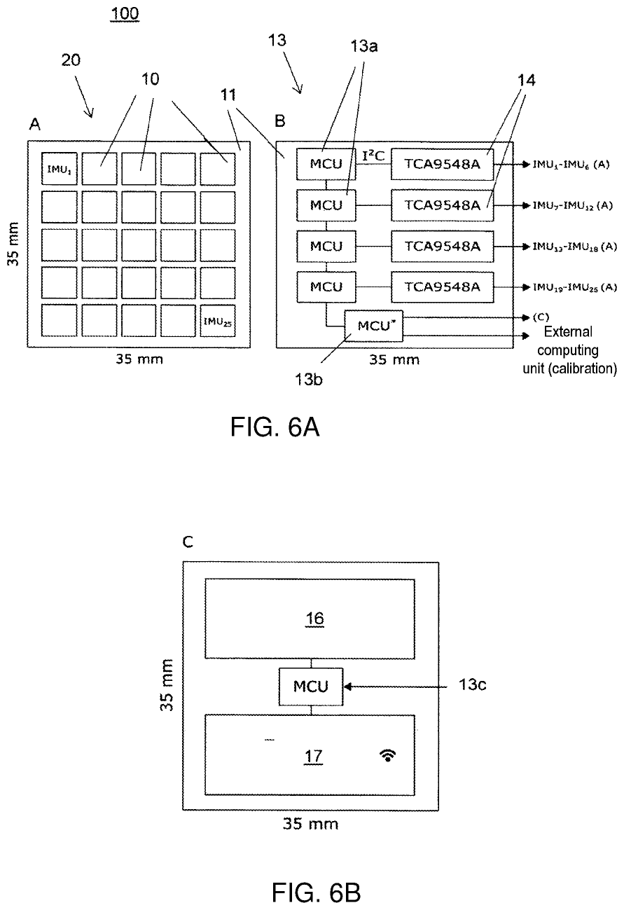

FIGS. 6A and 6B show the basic set-up of a device 100 for position determination in accordance with one preferred embodiment as a schematic illustration. The front side A and the rear side B are illustrated here. FIG. 6b shows an arrangement for displaying and transferring the data.

A multiplicity of sensors 10 embodied as inertial measurement units (IMUs) form a sensor arrangement 20, which is arranged on a carrier unit 11 embodied as a circuit board. The sensors 10 serve for measuring accelerations and rotation rates along and about the sensor body axes and are arranged on the front side A of the circuit board 11. In this example, the sensor or IMU arrangement consists of 25 sensors.

Furthermore, provision is made of an evaluation unit 13 in the form of a plurality of processors or microcontrollers (MCU) 13a, 13b, which are arranged on the rear side B of the circuit board 11. The main task of the processors or MCUs 13a, 13b is reading out the IMU data and calculating the position. In this case, the MCU 13b serves for weighting the individual results and for carrying out further calculation steps, and for presenting the result on a display 16 and/or for transmission to a receiving station by way of a transmitter and receiver 17 with the aid of an MCU 13c (see also FIG. 6B).

The evaluation unit 13 is designed such that it calculates a position value from the sensor data of the multiplicity of sensors 10 for each coordinate axis and for each point in time, wherein for example from the sensor data of the multiplicity of sensors 10, after a conversion into accelerations and rotation rates, positions are calculated separately for each IMU and then added in a weighted manner component by component. The weight for each sensor 10 and for each coordinate is ascertained by a calibration.

The system is of very compact design because of the small size of the IMU sensors 10 (approximately 4 mm×4 mm×1 mm). The area of the circuit board 11 with the sensor arrangement 20, which consists of 25 sensors 10 in this example, is 35 mm×35 mm.

Furthermore, I²C multiplexers or I²C switches 14 are arranged on the rear side B of the circuit board 11.

The device 100 shown here is designed such that a plurality of IMUs or sensors 10 can be read by one MCU 13a. The IMUs each have an I²C interface, such that they can be addressed separately by an MCU directly or if necessary via an I²C multiplexer.

For the case where the I²C address of the IMUs cannot be altered, the I²C multiplexers 14 afford a possibility for separately reading all IMUs connected thereto. In this case, each microcontroller 13a can select via address lines e.g. one of eight IMUs that are connected to an I²C multiplexer via separate channels.

In one possible variant, exactly one microcontroller is assigned to each IMU.

In this way, the circuit board 11 forms an IMU matrix circuit board with suitable computer architecture 13, 14 for reading out the IMU data via I²C multiplexers, for calculating the position by way of weight vectors by the processor or the MCU 13b, for transfer to a display 16 and to a PC during a calibration. In this case, the calculated position data or the sensor data or other relevant information can also be transmitted to a receiver.

A method for position determination is explained below by way of example, which method is preferably carried out using the device described above.

In order to determine the weights or the weights for each coordinate direction X, Y, Z for a more accurate position calculation, a number of possibilities are suitable, as described below.

For the sake of simplicity, the calibration method presented below relates only to the X-coordinate and has proved to be expedient in computer simulations.

The basic concept here is based on the random selection of Q subsets from the set of sensors 10 {S₁, . . . , S_{N}} having at least K and at most M elements:

_{Q}^{N}Λ_{K,M}={Tᵢ|i∈{1, . . . ,Q}Λ0<K≤|Tᵢ|≤M≤NΛTᵢ⊂{S₁, . . . ,S_{N}}ΛTᵢ good subset}, (15)

which makes this set a subset of the power set P({S₁, . . . ,S_{N}}).

Furthermore, the subsets are intended to be good subsets, i.e. the subsets or sensor combinations Tᵢ are distinguished by the fact that e.g. the accumulated deviation xₑᵣᵣₒᵣ, i.e. the sum of the deviations of the X-positions of the individual sensors 10 of the subset from the actual value of the current position X(t_{E}), at the end of the calibration time period T_{calib}=[0;t_{E}] is low. A more precise definition of the term good subsets is given further below.

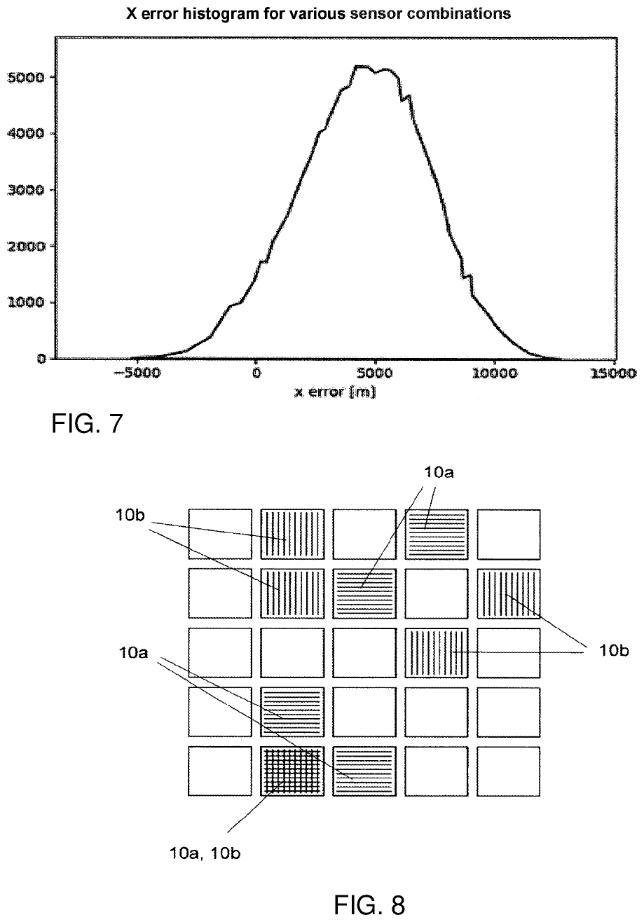

FIG. 7 shows a possible histogram of the accumulated deviations xₑᵣᵣₒᵣ per sensor subset in the case of a large number (>10⁵) of subsets of the sensor arrangement 20.

In general, therefore, only a relatively small portion of the possible sensor combination has the abovementioned property (xₑᵣᵣₒᵣ low). One possible definition of a good subset reads:

$$( i ) {T}_{i} is a good subset for the calculation of the X coordinate \\ ⇔ {\sum }_{n = 1}^{\vert {T}_{i} \vert} ( {X}_{{T}_{i} , n} ( {t}_{E} ) - X ( {t}_{E} ) ) = : {Δ}_{{T}_{i} , X} = : {x}_{error} < Limit \qquad ( 16 )$$

wherein the summation extends over the |Tᵢ| elements of the sensors 10 associated with the subset Tᵢ or their X-coordinate errors and X_{Ti,n} denotes the X-position of the n-th sensor associated with the subset Tᵢ at the end of the calibration time period T_{calib}=[0;t_{E}].

A similar criterion for selecting good subsets is represented by the following condition:

$$( ii ) {T}_{i} is a good subset for the calculation of the X coordinate \\ ⇔ ( \frac{1}{\vert {T}_{i} \vert} {\sum }_{n = 1}^{\vert {T}_{i} \vert} {X}_{{T}_{i} , n} ( {t}_{E} ) ) - X ( {t}_{E} ) = : {Δ}_{{T}_{i} , X} = : {x}_{error} < Limit \qquad ( 17 )$$

It demands that the centroid or mean value of the X-positions of the sensors 10 of the subset must not deviate too greatly from the actual value of the X-coordinate at the end of the calibration time period t_{E}.

The centroid of the X-coordinate X_{Ti} of such a good subset as the sum of the current X-positions of the individual sensors X_{Ti,n} associated with the subset divided by the number of elements of the subset

$${X}_{{T}_{i}} ( t ) : = \frac{1}{\vert {T}_{i} \vert} {\sum }_{n = 1}^{\vert {T}_{i} \vert} {X}_{{T}_{i} , n} ( t ) \qquad ( 18 )$$

may already be a usable approximation for the current X-position.

FIG. 8 shows one example of good subsets for calculating the X- and Y-coordinates of the current position. The horizontally striped IMUs or sensors 10a represent a good subset or good sensor combination for the calculation of the X-coordinate of the current position; the vertically striped sensors 10b form a good subset for the Y-coordinate. A sensor can also belong to both good subsets.

In the practical implementation of the calibration, the sensor data of all the IMUs or sensors 10 are recorded continuously for a certain time duration T_{calib}=[0; t_{E}] with a sufficiently high rate (e.g. t_{E}=10 min at 100 Hz), while a defined system movement is carried out with an exactly known trajectory with known start and end points and known start and end orientations. However, it is also conceivable for the sensor arrangement not to be moved with known orientation during the data recording.

If the IMU matrix consists of e.g. N=25 sensors 10 and the maximum cardinality of the subsets {Tᵢ} to be investigated is intended to be e.g. M=max({|Tᵢ|})=16 and the minimum number of sensors 10 per subset is intended to be K=min({|Tᵢ|})=6, then very many of such subsets exist:

$${\vert}^{N} {Λ}_{K , M} \vert = {\vert}^{25} {Λ}_{6 , 16} \vert = {\sum }_{m = 6}^{16} ( \begin{matrix}25 \\ m\end{matrix} ) = ( \begin{matrix}25 \\ 6\end{matrix} ) + ( \begin{matrix}25 \\ 7\end{matrix} ) + \text{…} + ( \begin{matrix}25 \\ 16\end{matrix} ) > 3 {10}^{7} \qquad ( 19 )$$

With N=36 sensors 10, billions of such subsets already exist, and so only a relatively small portion thereof can be checked in respect of the above quality criterion in an acceptable time.

The aim of the calibration is to identify such good subsets and to use them for ascertaining the weight vectors. What is sought is not just a subset whose associated current X-coordinate as centroid of the current X-coordinates of the sensors 10 associated with this subset best corresponds to the actual X-coordinate of the system, but rather a certain, predefined number Q of such good subsets (e.g. a few hundred in the case of 25 IMU sensors). In the simulations carried out, the value of Limit was typically between 10 m and 100 m. The smaller the level at which this value is fixed, the fewer the number of sensor combinations that can satisfy the criterion.

Because of the limited capacity with regard to memory and computing power, the calibration is preferably carried out with the aid of a PC or some other suitable external platform. FIGS. 6A and 6B described above show one possible set-up of the system. The clock rates of the microcontrollers (MCU) used are typically between 20 and 200 MHz and are thus slower than modern PCs by more than one order of magnitude. It is therefore advantageous to transfer the IMU data to a PC during the calibration in order to carry out the search for good sensor combinations and the weight calculation at the PC. The weight vectors are subsequently transferred from the PC to the system and are available for a position determination.

The two criteria specified can be replaced or supplemented by other quality criteria or conditions. In this regard, it is possible, for example, not just to consider the sum of the deviations with respect to the current X-position at the end of the recording t_{E}, but instead to demand that the criteria be satisfied at different points in time tₖ in the calibration time period where tₖ∈T_{calib},T_{calib}=[0; t_{E}].

Another condition may read, for example, that additionally the length of the trajectories averaged over the subsets must correspond to the actual length as well as possible.

An even stricter criterion, for a good sensor combination, may also demand that the sum of the deviations with respect to the true value, the sum being integrated over the entire measurement time of the calibration, must be as low as possible, which is equivalent to the demand that the averaged trajectory of the subset should correspond well to the actual trajectory.

During the calibration it is advantageous not to move the sensor matrix since in this case, too, the actual position and alignment are known at every point in time.

If the maximum number of sensors 10 which a good sensor combination is permitted to consist of and the minimum number of sensors 10 which a good sensor combination must consist of are predefined, for example, then one possibility for ascertaining good subsets consists in or comprises selecting a series of sensor combinations or subsets by way of a random number generator and checking in each case in respect of a quality criterion being satisfied by a suitable computer system until a predefined minimum number is found.

Strictly speaking, the use of the term subset is incorrect in the mathematical sense if sensors 10 are also permitted to occur multiply per sensor combination, e.g. T₃₄={S₄, S₉, S₉, S₉, S₁₂, S₁₉, S₂₁}, which may indeed be allowed algorithmically, but once again significantly increases the stated numbers with respect to the number of possible subsets. Simulation calculations both without and with the limitation of a single use per sensor combination hitherto have not yet revealed any difference in regard to the positional accuracy achieved. An influence on the calculation duration during the search for good subsets is possible, however.

If Q good subsets of this type are identified, firstly the X-coordinate of the centroid of the current position X_{Ti} is calculated for each of the subsets (i=1 . . . Q), the centroid being defined as above (formula (18)).

The X-coordinate X_{S} of the centroid of these centroids is subsequently calculated (the time dependence is omitted hereinafter):

Xₛ=(X_{T}_{₁}+X_{T}_{₂}+ . . . +X_{T}_{_{Q}})/Q (20)

The following example is intended to serve for elucidation. Only two good subsets or sensor combinations T₁ and T₂ (i.e. Q=2) are used. Let T₁={S₂, S₃, S₆, S₁₁, S₁₂, S₁₉} and T₂={S₁, S₃, S₆, S₁₁, S₁₄, S₁₇, S₂₁}, for example. It then holds true that: |T₁|=6 and |T₂|=7. The associated centroids are:

X_{T}_{₁}=(X₂+X₃+X₆+X₁₁+X₁₂+X₁₉)/6

X_{T}_{₂}=(X₁+X₃+X₆+X₁₁+X₁₄+X₁₇+X₂₁)/7 (21)

where Xᵢ denotes the X-coordinate of the current positions that is associated with the sensor Sᵢ. The centroid of these centroids is:

$$\begin{matrix}{X}_{s} = \frac{{X}_{{T}_{1}} + {X}_{{T}_{2}}}{2} ⇔ \\ {X}_{s} = \frac{\frac{{X}_{2} + {X}_{3} + {X}_{6} + {X}_{11} + {X}_{12} + {X}_{19}}{6} + \frac{{X}_{1} + {X}_{3} + {X}_{6} + {X}_{11} + {X}_{14} + {X}_{17} + {X}_{21}}{27}}{2} ⇔ \\ {X}_{s} = \frac{1}{14} {X}_{1} + \frac{1}{12} {X}_{2} + ( \frac{1}{12} + \frac{1}{14} ) {X}_{3} + ( \frac{1}{12} + \frac{1}{14} ) {X}_{6} + ( \frac{1}{12} + \frac{1}{14} ) {X}_{11} + \frac{1}{12} {X}_{12} + \frac{1}{14} {X}_{14} + \frac{1}{14} {X}_{17} + \frac{1}{12} {X}_{19} + \frac{1}{14} {X}_{21} \\ {X}_{s} \approx 0.071 {X}_{1} + 0.083 {X}_{2} + 0.155 {X}_{3} + 0.155 {X}_{6} + 0.155 {X}_{11} + 0.08 \; 3 {X}_{12} + 0.071 {X}_{14} + 0.071 {X}_{17} + 0.083 {X}_{19} + 0.071 {X}_{21}\end{matrix} \qquad ( 22 )$$

This expression can be converted to the following form:

$${X}_{s} = {\sum }_{i = 1}^{N} w {x}_{i} {X}_{i} = w {x}_{1} {X}_{1} + w {x}_{2} {X}_{2} + \text{…} + {wx}_{N} {X}_{N} \approx {X}_{curr} \qquad ( 23 )$$

and thus represents a linear combination of the current X-coordinates of the individual sensors and can be used as an approximation for the X-coordinate of the current position X_{curr}. The coefficients form the weight vector sought for the X-coordinate direction. As shown by the example, individual components of a weight vector can also be 0 (e.g. wx₄=wx₅=wx₇=wx₈=wx₉=wx₁₀=0, since the associated values X₄, X₅, X₇, X₈, X₉, X₁₀ are not used in the centroid calculation).

Even this simple example demonstrates that the more frequently sensors occur in good subsets, the greater their weights (S₃, S₆, S₁₁ occur in both good subsets; accordingly, their weight is greater than that of the other sensors). It can furthermore be seen that the weights are also dependent on the number of elements in a good subset. By way of example, the weights of the sensors S₁ ∈ T₂ and S₂ ∈ T₁ (wx₁=0.071; wx₂=0.083) differ because of the fact that the good subsets of which they are elements have a different cardinality: |T₁|=6≠|T₂|=7. The greater the cardinality of the good subsets in which the sensors occur, the smaller the weights of the sensors contained in the linear combination (see formula 23).

The more good sensor combinations there are, the more balanced the weighting becomes, such that the weight vector converges in the limiting case:

$$w x = ( w {x}_{1} , … , w {x}_{N} ) \to ( \frac{1}{N} , … , \frac{1}{N} ) ,$$

which is tantamount to a traditional averaging.

A typical example of weight factors for the calculation of the current X-coordinate in the case of an arrangement of 36 IMUs is:
wx=(0.034, 0.013, 0.022, 0.025, 0.022, 0.032, 0.036, 0.036, 0.023, 0.026, 0.021, 0.036, 0.030, 0.039, 0.044, 0.027, 0.028, 0.025, 0.029, 0.030, 0.017, 0.028, 0.037, 0.019, 0.023, 0.030, 0.031, 0.027, 0.010, 0.029, 0.035, 0.031, 0.035, 0.017, 0.024, 0.030)

It should be recalled once again that the above-described way of ascertaining weights does not constitute the only possibility and should be regarded merely as an example. In this respect, alternatively for formula 22 for an approximation for the current position it is possible to carry out a weighting of the centroids X_{Ti} of the good subsets with the cardinality of the associated good subsets:

$${X}_{s} = \frac{\vert {T}_{1} \vert {X}_{{T}_{1}} + \vert {T}_{2} \vert {X}_{{T}_{2}}}{\vert {T}_{1} \vert + \vert {T}_{2} \vert} \qquad ( 24 )$$

Alternatively, the abovementioned deviations Δ_{T}_{ᵢ}_{,X}=xₑᵣᵣₒᵣ can also be used to correspondingly weight the centroids X_{Ti} of the good subsets:

Xₛ=d₁X_{T}_{₁}d₂X_{T}_{₂}+ . . . +d_{Q}X_{T}_{_{Q}} (24)

wherein the coefficients dᵢ are inversely proportional to the deviations Δ_{T}_{ᵢ}_{,X}=xₑᵣᵣₒᵣ, that is to say dᵢ˜1/xₑᵣᵣₒᵣ. This expresses the fact that the coefficients dᵢ turn out to be larger, the smaller the accumulated deviations or the errors of the mean values Δ_{T}_{ᵢ}_{,X}=xₑᵣᵣₒᵣ of the associated sensor combinations Tᵢ. This expression can again be represented as a linear combination of the X-coordinates of the current positions originating from the N IMUs of the matrix:

Xₛ=wx₁X₁+wx₂X₂+ . . . +wx_{N}X_{N}

and can likewise be a good approximation for the current X-position coordinate: X_{S}(t)≈Xₜᵣᵤₑ(t).

Finally, attention should also be drawn to the possibility that a weight wx=(wx₁, . . . ,wx_{N}) for the calculation of the actual or current X-coordinate can also be derived from the solution of the following system of equations. On the left-hand side there are values of the actual X-position of the system at different points in time during the calibration process, wherein their number W must exceed the number N of IMU sensors (W>N). This involves an overdetermined system of equations in respect of N unknowns {wx₁, . . . , wx_{N}}, which system of equations can be treated numerically using various approaches in order to determine the best weight wx=(wx₁, . . . ,wx_{N}):

$$\begin{matrix}X ( {t}_{1} ) = w {x}_{1} {X}_{1} ( {t}_{1} ) + w {x}_{2} {X}_{2} ( {t}_{1} ) + \text{…} + w {x}_{N} {X}_{N} ( {t}_{1} ) \\ X ( {t}_{2} ) = w {x}_{1} {X}_{1} ( {t}_{2} ) + w {x}_{2} {X}_{2} ( {t}_{2} ) + \text{…} + w {x}_{N} {X}_{N} ( {t}_{2} ) \\ ⋮ \\ X ( {t}_{W} ) = w {x}_{1} {X}_{1} ( {t}_{W} ) + w {x}_{2} {X}_{2} ( {t}_{W} ) + \text{…} + w {x}_{N} {X}_{N} ( {t}_{W} ) \\ where W > N ⩓ {t}_{i} ∈ {T}_{c a l i b} , {T}_{c a l i b} = [ 0 ; {t}_{E} ] .\end{matrix} \qquad ( 25 )$$

If powers of the current X-coordinates of the individual sensors are also permitted in the development of the current X-coordinate, then the following system of equations in respect of 2N unknowns {wx₁₁, wx₁₂, . . . , wx_{N1}, wx_{N2}} arises in the case of squares:

$$\begin{matrix}X ( {t}_{1} ) = w {x}_{11} {X}_{1} ( {t}_{1} ) + w {x}_{12} {X}_{1}^{2} ( {t}_{1} ) + \text{…} + w {x}_{N 1} {X}_{N} ( {t}_{1} ) + w {x}_{N 2} {X}_{N}^{2} ( {t}_{1} ) \\ X ( {t}_{2} ) = w {x}_{11} {X}_{1} ( {t}_{2} ) + w {x}_{12} {X}_{1}^{2} ( {t}_{2} ) + \text{…} + w {x}_{N 1} {X}_{N} ( {t}_{2} ) + w {x}_{N 2} {X}_{N}^{2} ( {t}_{2} ) \\ ⋮ \\ X ( {t}_{2 W} ) = w {x}_{11} {X}_{1} ( {t}_{2 W} ) + w {x}_{12} {X}_{1}^{2} ( {t}_{2 W} ) + \text{…} + w {x}_{N 1} {X}_{N} ( {t}_{2 W} ) + w {x}_{N 2} {X}_{N}^{2} ( {t}_{2 W} ) \\ where 2 W > 2 N ⩓ {t}_{i} ∈ {T}_{c a l i b} , {T}_{c a l i b} = [ 0 ; {t}_{E} ] .\end{matrix} \qquad ( 26 )$$

Since the weight vector

wx=(wx₁₁,wx₁₂, . . . ,wx_{N1},wx_{N2}) (27)

then has twice as many components, the number of measurements during the calibration process and thus the number of equations for an overdetermination of the system should be increased accordingly.

It is advantageous, for example, to use weight vectors which are adapted for different time segments Iₖ=[t_{k,a};t_{k,b}] for ascertaining the current position. The following development (again only for the X-coordinate) thus results for each time segment:

$$\begin{matrix}X ( t ) = {\sum }_{i = 1}^{N} w {x}_{i , {I}_{k}} {X}_{i} ( t ) , & t ϵ {I}_{k}\end{matrix} \qquad ( 28 )$$

with the associated weight vectors

wx_{I}_{ₖ}=(wx_{1,I}_{ₖ}, . . . ,wx_{N,I}_{ₖ}) (29)

In order to be able to calculate position coordinates for every point in time, the union of the time segments must cover the time period T of interest:

$$T ⋐ {⋃}_{k} {I}_{k}$$

As already mentioned above, the previous explanations apply only to the X-coordinate of the current position, for the sake of simplicity. For the remaining spatial coordinates, Y and Z, an analogous procedure should be adopted when determining the associated weights.

It generally holds true that the weight vectors calculated by different methods need not necessarily be identical.

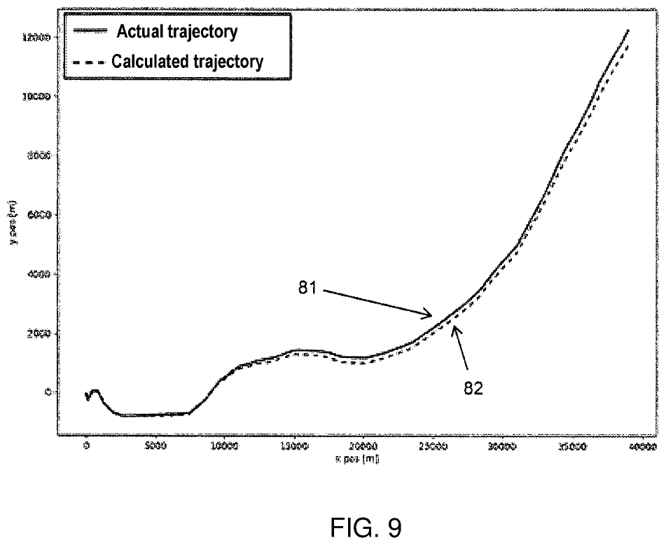

FIGS. 9, 10A and 10B and 11 show results of simulation calculations for a planar movement lasting one hour, and a planar movement lasting 12 minutes.

In this case, FIG. 9 shows an example of an actual planar trajectory 81 (illustrated as a solid line) and a planar trajectory 82 (illustrated as a dashed line) calculated by a weight vector for an arrangement of 25 IMU sensors 10.

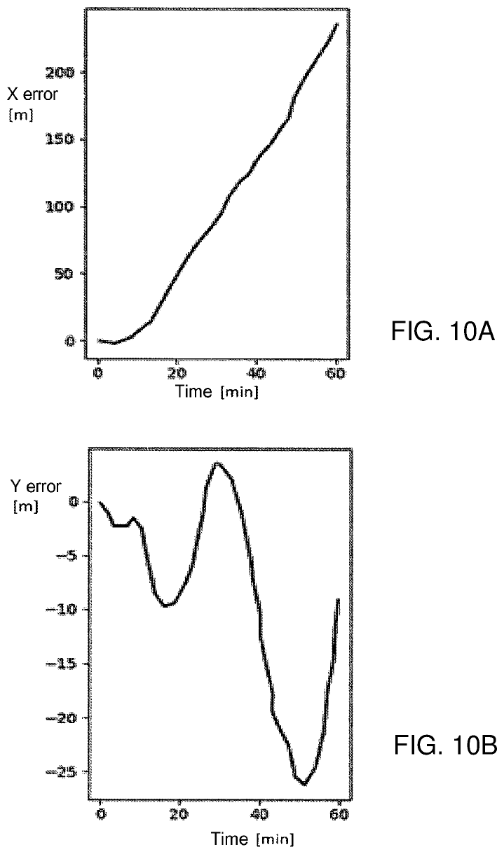

FIGS. 10A and 10B show the temporal development of the X- and Y-errors of the calculated trajectory shown in FIG. 9.

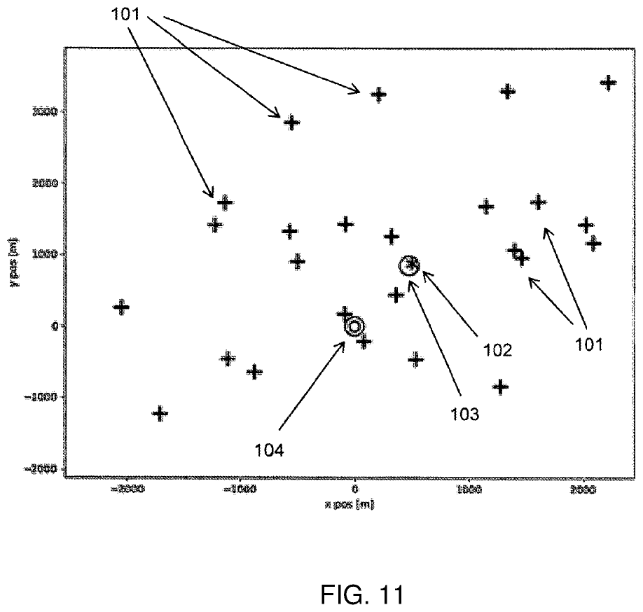

FIG. 11 shows an example of the movement of a person carrying the device 100 after 12 minutes; the crosses show the positions 101 ascertained with the aid of the individual sensors 10 of the IMU matrix; the asterisk shows the position 102 determined by way of a weight vector according to the disclosure herein and coincides well with the actual position 103, illustrated as a circle. The starting position 104 is illustrated as a double circle.

In principle, all the considerations above also apply to the case where a weighting of the linear accelerations and rotation rates or rotation angles of the individual sensors 10 is carried out in order to calculate the current orientation and position with the aid of the calculated substitute values.

The role of the coordinates of the individual sensors 10 is undertaken by the components of the linear acceleration and angular velocity or rotation angles along and about the corresponding axes. In this case, too, during the calibration the sensor data of all IMUs are read out continuously for a certain calibration time duration with a sufficiently high rate (e.g. 15 min at 200 Hz), while a defined system movement is carried out with exactly known initial conditions, known trajectory and known temporal profile of acceleration and angular velocity or orientation, such that values for the linear acceleration and the rotation rate are present for every point in time (after transformation of the raw sensor data) for each sensor 10 and for each sensor axis.

The following, for example, can be demanded of good sensor combinations or subsets for the X-axis for calculating the rotation rate, the rotation angle and the linear acceleration:

$$\begin{matrix}{T}_{i} is a good subset for the calculation of the rotation rate \\ about the sensor X - axis ⇔ {\sum }_{n = 1}^{\vert {T}_{i} \vert} ( {ω}_{X , {T}_{i} , n} ( {t}_{E} ) - {ω}_{X} ( {t}_{E} ) ) = : {Δ}_{{T}_{i} , {ω}_{X}} = : {ω}_{error} < {Limit}_{ω} \\ and & ( 30 ) \\ {T}_{i} is a good subset for the calculation of the rotation angle \\ about the ( world ) X - axis ⇔ {\sum }_{n = 1}^{\vert {T}_{i} \vert} ( {φ}_{X , {T}_{i} , n} ( {t}_{E} ) - {φ}_{X} ( {t}_{E} ) ) = : {Δ}_{{T}_{i} , {φ}_{X}} = : {φ}_{error} < {Limit}_{φ} \\ and & ( 31 ) \\ \\ {T}_{i} is a good subset for the calculation of the linear acceleration \\ about the sensor X - axis ⇔ {\sum }_{n = 1}^{\vert {T}_{i} \vert} ( {a}_{X , {T}_{i} , n} ( {t}_{E} ) - {a}_{X} ( {t}_{E} ) ) = : {Δ}_{{T}_{i} , {a}_{X}} = : {a}_{error} < L i m i {t}_{a} & ( 32 )\end{matrix}$$

Analogous definitions apply to the Y- and Z-axes. ω_{X,T}_{ᵢ}_{,n}(t_{E}) and a_{X,T}_{ᵢ}_{,n}(t_{E}) denote the rotation rate about and respectively the linear acceleration along the sensor X-axis of the n-th sensor of the subset Tᵢ and φ_{X,T}_{ᵢ}_{,n}(t_{E}) denotes the rotation angle of the n-th sensor of the subset Tᵢ about the world X-axis at the end of the calibration time period T_{calib}.

It is likewise possible to demand the stated criteria for good sensor combinations at different points in time during the calibration, not just at the end of the calibration time period t_{E}. If for example Z=(0, t₁, t₂, t_{E}) shall be a decomposition of the calibration time period T_{calib}=[0; t_{E}], then for a good sensor subset for example it can be demanded that the above criteria be satisfied for all points in time of the decomposition (possibly with the exception of t=0).

As already mentioned above, other criteria are also possible.

The various methods for deriving the weight vectors from a number of good subsets or by way of the solution of an overdetermined system of equations have already been described further above.

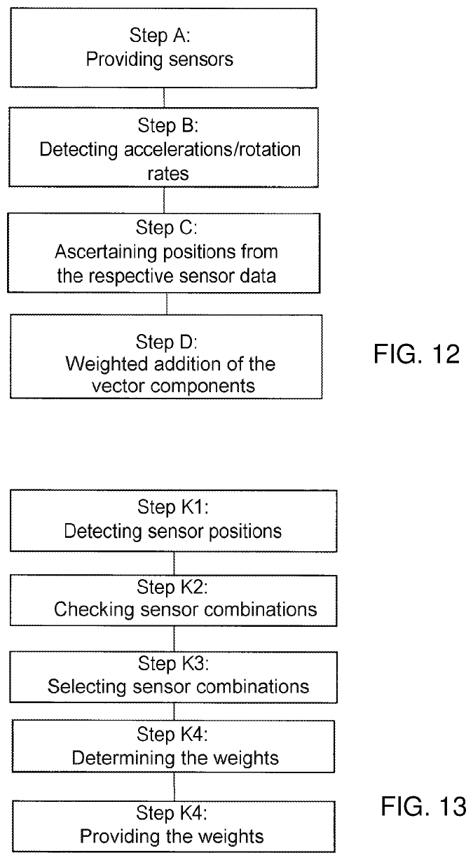

To supplement the method described above, FIG. 12 schematically illustrates a block diagram of the method. The steps are designated as follows:

Step A: providing the sensors;

Step B: detecting the accelerations and rotation rates;

Step C: ascertaining the positions that result from the data of each sensor;

Step D: weighted addition of the vector components of the ascertained positions.

The individual steps of the method have been described in detail above, to which reference is made here.

FIG. 13 supplementarily shows a block diagram which schematically illustrates a calibration in accordance with one example embodiment. The steps are designated as follows:
Step K1: detecting positions which are ascertained by a multiplicity of sensors at a known position;
Step K2: checking a multiplicity of different sensor combinations in respect of at least one quality criterion being satisfied;
Step K3: selecting those sensor combinations which satisfy at least one quality criterion;
Step K4: determining the weights for the selected sensor combinations;
Step K5: providing the weights for the weighted addition when carrying out the method for position determination.

The individual steps of the calibration have been described in detail above, to which reference is made here.

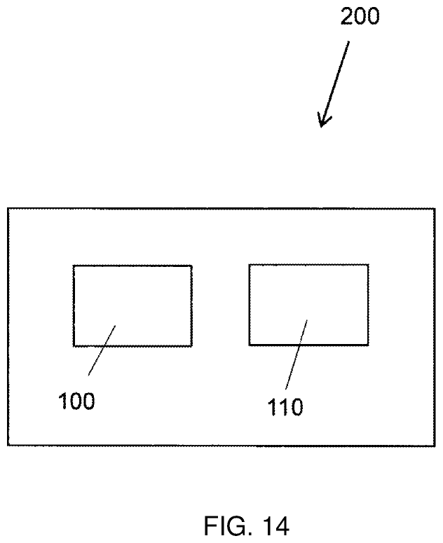

FIG. 14 supplementarily shows a calibration system 200 in accordance with one preferred embodiment of the disclosure herein, comprising a calibration unit 110 for calibrating the device 100 such as has been described above. The calibration unit 110 comprises units for carrying out the calibration described in detail above.

If a variation of the weights e.g. because of scaling or bias values of the individual sensors that vary in a temperature-dictated manner is to be expected during use of the system, for example because of a fluctuating ambient temperature or an increasing operating temperature, one embodiment of the disclosure herein provides for thermally decoupling the system from the surroundings and/or using thermocouples for temperature compensation, which in each case constitutes a helpful measure for reducing errors.

In accordance with one embodiment, an operationally dictated temporal temperature gradient can be reduced by early turn-on before a calibration and before use.

Moreover, the system or the device 100 or at least the IMU sensors 10 can remain permanently turned on by a corresponding power supply, which usually does not constitute an excessive limitation in the case of a power of less than 20 mW/IMU (MPU6050).

The calibration, as described above, should advantageously only ever be carried out after a certain turn-on duration or operating time since then a constant bias error can more likely be assumed, and it is also advantageous if this calibration is effected close to the time of the actual use, without the system being turned off in the meantime, which also solves the “turn-on to turn-on problem” already mentioned.

Moreover, a user can operate two systems, one of which is calibrated while the other system is currently in use.

A further possibility for increasing the accuracy consists in or comprises carrying out the calibration over a long time period, for example over a few hours, and subdividing it into temporal segments, for each of which a dedicated weight is determined for each coordinate.

If a use chronologically directly succeeds the calibration and if the system is not turned off in the meantime, then it is possible to extrapolate a current weight vector for each coordinate from the associated weight vectors of the preceding portions of the calibration by a fit.

In contrast to the position determination, for which there is no possibility of coordination with other systems that are protected against manipulation and are insensitive to disturbances, in the case of the determination of the alignment of the system it is advantageous under certain circumstances and to a certain degree to check the calculated alignment for consistency with the aid of a magnetometer, and to correct it if appropriate.

Particularly if the Earth's magnetic field is not deformed by obstacles in an unknown manner, it is possible to measure the actual alignment of the system in relation to the orientation of the magnetic lines of the Earth's magnetic field and to use it for correcting the calculated movement direction or orientation.

Under specific prerequisites, the position error resulting from the processing of the acceleration data can also be reduced. By way of example, an external sensor system or generally external information can be used to establish whether an actual movement relative to the surface of the Earth takes place. In this case, it is also possible, if appropriate, to estimate the magnitude of the velocity. In this regard, for example, a coupling of the system or the device 100 to e.g. a driveshaft or the wheels of a land vehicle can provide information about whether and how fast the system is moving or it is in the state of rest.

This information, together with knowledge of the maximum possible velocity, for example, can be used to coordinate the system velocity calculated following a simple integration of the acceleration data and thus to reduce the error in the calculation of the instantaneous or current position.

If the system or the device 100 is used by persons moving in walking fashion, in accordance with an advantageous further configuration of the disclosure herein, steps are detected e.g. by way of heuristic considerations of the sensor data. In the absence of steps, the velocity is extremely probably zero. Thus, the calculated velocity is corrected and a drift or the error in the position calculation is reduced.

In accordance with a further particular configuration of the disclosure herein, measurement data of physical variables such as water or air pressure are used for calculating the diving depth or the height above the ground in order to reduce errors at least for the Z-coordinate or height coordinate even further.

If rapid linear or rotational system movements or accelerations can be precluded because of mass inertia, for example, high-frequency components are advantageously eliminated from the raw sensor values of all the sensors by way of an adapted low-pass filtering or else by way of a history fit. The influence of noise or vibrations is reduced as a result. By contrast, if a drift-like movement is not expected, then a high-pass filtering is advantageously effected in order to minimize drift.

The disclosure herein can advantageously also be used in combination with other localization technologies. If, for example, the reception of the GPS signal is possible only sporadically in a manner dictated by the surroundings, then the received GPS coordinates can be used to correct the position calculated continuously with the IMU matrix.

### LIST OF REFERENCE SIGNS

1 actual value
2 value ascertained from sensor data
10 inertial measurement unit/sensor
10a sensors of a good sensor combination (X-direction)
10b sensors of a good sensor combination (Y-direction)
11 carrier unit/circuit board
13 evaluation unit
13a, 13b, 13c processors/MCUs
14 I²C multiplexers
16 display
17 transmitter and receiver
20 sensor arrangement
41 current sensor position
42 rest position
51 error of the calculated X-coordinate
81 actual planar trajectory
82 calculated planar trajectory
101 positions ascertained by sensors
102 position determined by way of weight vector
103 actual position
104 starting position
110 calibration unit
200 calibration system
A front side
B rear side

1. A method for position determination by inertial navigation, wherein a current position is determined from a known starting position and starting orientation by detecting accelerations and rotation rates, comprising:
providing individual sensors for detecting accelerations and rotation rates;
calculating the accelerations and rotation rates acting on the sensors along or about three sensor axes over a time period; and
wherein a position is ascertained in each case from data of the individual sensors and vector components of ascertained positions are subsequently added in a weighted manner, wherein weights are ascertained by calibration.

2. The method of claim 1, wherein for ascertaining the current position, a nonlinear combination of the vector components of the positions of a multiplicity of sensors is formed, wherein the vector components and in each case at least the second power thereof are summed in a separately weighted manner.

3. The method of claim 1, wherein for calibration, from a multiplicity of sensor combinations for each coordinate direction a number of sensor combinations are selected, each of which satisfies at least one quality criterion.

4. The method of claim 3, wherein for satisfying the quality criterion for each coordinate direction:
4.1. at an end of the calibration a sum of the deviations of the coordinates of the positions of the individual sensors of the respective sensor combination from an actual value of the coordinate of the current position lies below a defined limit value; and/or
4.2. at the end of the calibration a deviation of the centroid of the coordinates of the positions of the individual sensors of the respective sensor combination from the actual value of the coordinate of the current position lies below a defined limit value.

5. The method of claim 3, wherein for satisfying the quality criterion for each coordinate direction a sum, integrated over the calibration time period, of the deviations of the individual coordinates of the positions of the sensors associated with the sensor combination from the actual value of the coordinate of the current position lies below a defined limit value.

6. The method of claim 3, wherein a number of sensor combinations are selected which satisfy at least one quality criterion at different points in time during the calibration.

7. The method of claim 3, wherein a predefined minimum and/or maximum number of sensor combinations which satisfy the quality criterion are selected.

8. The method of claim 3, wherein for determining weights:
for each of the selected sensor combinations a spatial coordinate of the centroid of the corresponding coordinates of the current positions of the individual sensors of the sensor combination is calculated; and/or
a spatial coordinate of the centroid of the centroids of the corresponding coordinates is calculated; and/or
the deviations of the corresponding coordinates of the current positions of the individual sensors of the selected sensor combinations from the actual value of the corresponding coordinate of the current position are used for each coordinate direction; and/or
an overdetermined system of equations is solved for each coordinate direction.

9. The method of claim 3, wherein weights of the sensors for each coordinate are formed from coefficients of a linear combination of corresponding coordinates of the positions associated with the sensors.

10. A device for position determination by inertial navigation, comprising:
a multiplicity of sensors for detecting accelerations and rotation rates along or about the respective sensor axis thereof; and
an evaluation unit for calculating a current position from detected accelerations and rotation rates;
the evaluation unit is configured to ascertain a position in each case from the data of the individual sensors and subsequently adds the vector components of the ascertained positions in a weighted manner, wherein the weights are ascertained by a calibration of the sensors.

11. The device of claim 10, configured to thermally decoupling the sensors from the surroundings and/or by thermocouples for compensating for temperature changes.

12. The device of claim 10, comprising a unit for mechanically damping the sensors.

13. The device of claim 10, for use in a spacecraft, aircraft, land vehicle or watercraft or aerial vehicle, and/or embodied as a portable navigation device for persons and/or for use under water.

14. A calibration system, comprising the device of claim 10.
